(19) United States
(12) Patent Application Publication
(10) Pub. No.: US 2026/0323694 A1
(43) Pub. Date: Oct. 15, 2026

(54) METHOD AND DEVICE FOR ADDRESSING COLLISIONS AMONG TIME WINDOWS FOR OPERATIONS RELATED TO DIFFERENT NETWORKS

(71) Applicant: APPLE INC., Cupertino, CA (US)

(72) Inventors: Qiming Li, Beijing (CN); Rolando E Bettancourt Ortega, Munich (DE); Yuexia Song, Beijing (CN); Yang Tang, San Jose, CA (US); Xiang Chen, Campbell, CA (US); Jie Cui, San Jose, CA (US); Dawei Zhang, Saratoga, CA (US); Manasa Raghavan, Sunnyvale, CA (US)

(21) Appl. No.: 19/122,604

(22) PCT Filed: Nov. 4, 2022
(86) PCT No.: PCT/CN2022/129757

§ 371 Date: Apr. 18, 2025

(51) Int. Cl. H04W 74/0816; H04B 7/06; H04B 17/309; H04B 17/318; H04W 72/231; H04W 74/0833; H04W 76/20

(52) U.S. Cl. CPC H04W 74/0816; H04B 7/0632; H04B 17/328; H04B 17/346; H04W 72/231; H04W 74/0833; H04W 76/20

(57) ABSTRACT

The present disclosure relates to a method and a device for addressing collisions among time windows for operations related to different networks. there is provided a wireless device, comprising: at least one antenna; at least one radio coupled to the at least one antenna; and a processor coupled to the at least one radio; wherein the processor is configured to take repeatedly appeared first time windows as occasions to perform one or more first operations related to a first network; and take repeatedly appeared second time windows as occasions to perform one or more second operations related to a second network different from the first network, wherein the processor is further configured to handle at least one collision between a first time window as an occasion to perform the one or more first operations within the first time window and a second time window as an occasion to perform the one or more second operations within the second time window by either dropping the occasion to perform the one or more first operations within the first time window or dropping the occasion to perform the one or more second operations within the second time window at least according to at least one sharing factor, the at least one sharing factor defines a relationship between a number of dropped occasions to perform the one or more first operations and a number of dropped occasions to perform the one or more second operations.

### TECHNICAL FIELD

This application relates generally to wireless communication systems, including a wireless device, a cellular base station, methods, an apparatus for addressing collisions among time windows for operations related to different networks.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mm Wave) range of FR2 may have smaller coverage but potentially higher available bandwidth than bands in the FR1. Skilled persons will recognize these frequency ranges, which are provided by way of example, may change from time to time or from region to region.

### SUMMARY

Embodiments relate to device, method, apparatus, computer-readable storage medium and computer program product for wireless communication.

According to an aspect, there is provided a wireless device, comprising: at least one antenna; at least one radio coupled to the at least one antenna; and a processor coupled to the at least one radio; wherein the processor is configured to take repeatedly appeared first time windows as occasions to perform one or more first operations related to a first network; and take repeatedly appeared second time windows as occasions to perform one or more second operations related to a second network different from the first network, wherein the processor is further configured to handle at least one collision between a first time window as an occasion to perform the one or more first operations within the first time window and a second time window as an occasion to perform the one or more second operations within the second time window by either dropping the occasion to perform the one or more first operations within the first time window or dropping the occasion to perform the one or more second operations within the second time window at least according to at least one sharing factor, the at least one sharing factor defines a relationship between a number of dropped occasions to perform the one or more first operations and a number of dropped occasions to perform the one or more second operations.

According to another aspect, there is provided a cellular base station, comprising: at least one antenna; at least one radio coupled to the at least one antenna; and a processor coupled to the at least one radio; wherein the processor is configured to: transmit, via the at least one radio to a wireless device, a Radio Resource Control (RRC) message indicating at least one sharing factor causing the wireless device to handle at least one collision between a first time window as an occasion to perform one or more first operations related to a first network within the first time window and a second time window as an occasion to perform one or more second operations related to a second network within the second time window by either dropping the occasion to perform the one or more first operations within the first time window or dropping the occasion to perform the one or more second operations within the second time window at least according to the at least one sharing factor, a plurality of said first time windows appear repeatedly as occasions for the wireless device to perform said one or more first operations, and a plurality of said second time windows appear repeatedly as occasions for the wireless device to perform said one or more second operations, wherein the at least one sharing factor defines a relationship between a number of dropped occasions to perform the one or more first operations and a number of dropped occasions to perform the one or more second operations.

According to another aspect, there is provided a method for a wireless device, comprising: taking repeatedly appeared first time windows as occasions to perform one or more first operations related to a first network; and taking repeatedly appeared second time windows as occasions to perform one or more second operations related to a second network different from the first network, wherein the method further comprising handling at least one collision between a first time window as an occasion to perform the one or more first operations within the first time window and a second time window as an occasion to perform the one or more second operations within the second time window by either dropping the occasion to perform the one or more first operations within the first time window or dropping the occasion to perform the one or more second operations within the second time window at least according to at least one sharing factor, the at least one sharing factor defines a relationship between a number of dropped occasions to perform the one or more first operations and a number of dropped occasions to perform the one or more second operations.

According to another aspect, there is provided a method for a cellular base station, comprising: transmitting, via the at least one radio to a wireless device, a Radio Resource Control (RRC) message indicating at least one sharing factor causing the wireless device to handle at least one collision between a first time window as an occasion to perform one or more first operations related to a first network within the first time window and a second time window as an occasion to perform one or more second operations related to a second network within the second time window by either dropping the occasion to perform the one or more first operations within the first time window or dropping the occasion to perform the one or more second operations within the second time window at least according to the at least one sharing factor, a plurality of said first time windows appearing repeatedly as occasions for the wireless device to perform said one or more first operations, and a plurality of said second time windows appearing repeatedly as occasions for the wireless device to perform said one or more second operations, wherein the at least one sharing factor defines a relationship between a number of dropped occasions to perform the one or more first operations and a number of dropped occasions to perform the one or more second operations.

According to another aspect, there is provided an apparatus, comprising: a processor configured to cause a wireless device to: take repeatedly appeared first time windows as occasions to perform one or more first operations related to a first network; and take repeatedly appeared second time windows as occasions to perform one or more second operations related to a second network different from the first network, wherein the processor is further configured to handle at least one collision between a first time window as an occasion to perform the one or more first operations within the first time window and a second time window as an occasion to perform the one or more second operations within the second time window by either dropping the occasion to perform the one or more first operations within the first time window or dropping the occasion to perform the one or more second operations within the second time window at least according to at least one sharing factor, the at least one sharing factor defines a relationship between a number of dropped occasions to perform the one or more first operations and a number of dropped occasions to perform the one or more second operations.

According to another aspect, there is provided computer-readable storage medium storing program instructions, wherein the program instructions, when executed by a computer system, cause the computer system to perform the method of any of the above aspects.

According to another aspect, there is provided a computer program product, comprising program instructions which, when executed by a computer, cause the computer to perform the method of any of the above aspects.

The techniques described herein may be implemented in and/or used with a number of different types of devices, including but not limited to cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 illustrates an example operation configuration for a UE connected to two networks.

FIG. 4 illustrates an example situation where time windows for performing operation(s) related to a first network collide with time windows for performing operation(s) related to a second network.

FIG. 5 illustrates an example solution to address the collision between first time windows for a first network operations and second time windows for a second network operations according to an embodiment of the present disclosure.

FIG. 6A illustrates an example solution to address the collision between first time windows for a first network operations and second time windows comprising a plurality of patterns for a second network operations according to an embodiment of the present disclosure.

FIG. 6B illustrates an example solution to address the collision between first time windows for a first network operations and second time windows comprising a plurality of patterns for a second network operations according to an embodiment of the present disclosure.

FIG. 7A illustrates an example RRC message indicating the at least one sharing factor according to an embodiment of the present disclosure.

FIG. 7B illustrates an example RRC message indicating the at least one sharing factor according to an embodiment of the present disclosure.

FIG. 8 illustrates an example of aperiodic triggered second time window(s) skip according to an embodiment of the present disclosure.

FIG. 9 illustrates an example of increased latency for Primary Synchronization Signal (PSS)/Secondary synchronization signal (SSS) detection in FR1 as a type RRM procedure.

FIG. 10 illustrates an example flow diagram for a wireless device according to the present disclosure.

FIG. 11 illustrates an example flow diagram for a network device according to the present disclosure.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

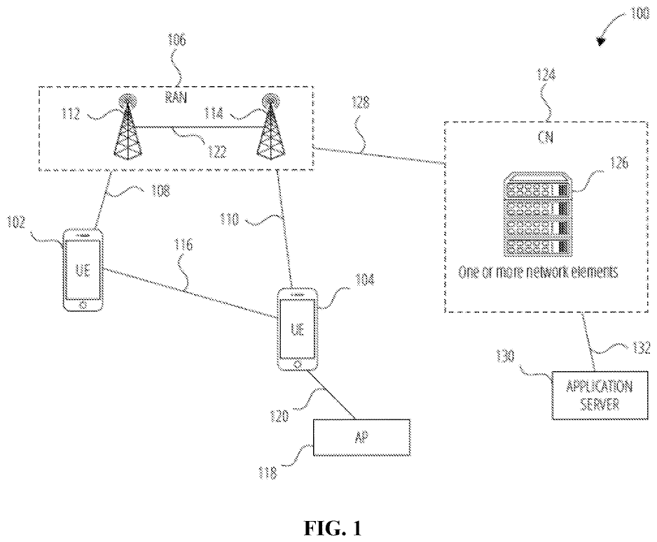

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

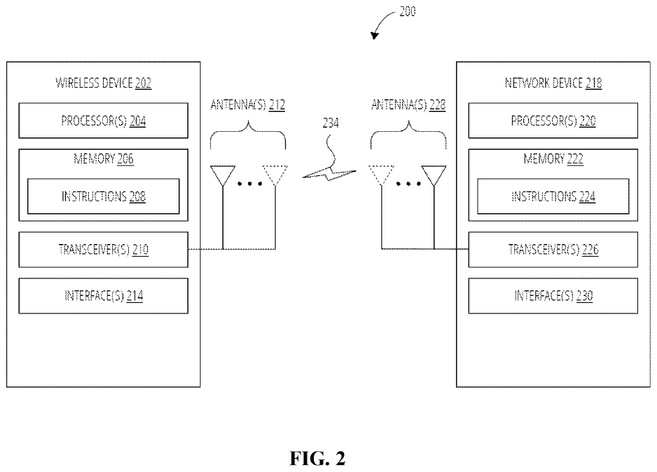

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-FiR, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

The following description will take 5G NR as an example to illustrate the concept of the present disclosure, but it should be understood that the solution of the present disclosure is applicable to any appropriate mobile communication technology (e.g. 6G or any applicable advanced mobile communication technology).

In the following description, gNB is sometimes used to represent the control device at the base station side in a wireless communication network. It should be understood this is for illustrative purpose only but not restrictive. A base station based on any appropriate mobile communication technology is applicable.

It becomes possible for a UE to connect to multiple networks so as to, for example, increase connectivity/reliability, enable different user profiles for one user, etc. For example, Multi-Universal Subscriber Identity Module (MUSIM) enables a UE to realize such enhanced functions. An MUSIM UE may host multiple USIMs which enables to connect to two or more different networks. For a UE intending to connect to multiple networks, it is necessary for the UE to perform some interactions with the multiple networks, regardless of whether the UE is in the RRC connected state with one network (e.g. the primary network) among the multiple networks and in RRC idle/inactive state with other networks (e.g. secondary networks) or the UE is in the RRC connected state with all the multiple networks. At least some of such interactions are performed in some specific time windows. Such time windows can repeatedly appear (e.g. periodically or aperiodically (e.g. triggered by some condition(s)/event(s), etc.)) with a certain starting position (e.g. an offset), a certain length and/or a certain repetition cycle. For example, one time window can be regarded as one occasion for the UE to perform one or more operations related to a network of the multiple networks.

For example, for any secondary network among the plurality of networks, the UE can perform operations (such as Radio Resource Management (RRM) measurement, paging reception, system information (e.g. information regarding positioning under idle state) reception, etc.) related to the secondary network only within specific time windows. For example, such time windows for secondary network operations can repeatedly appear (e.g. periodically or aperiodically. For example, in every time window for secondary network operations, the UE can perform operation(s) related to the secondary network same with or different from the operation(s) performed in another time window. Such a time window for performing operations related to the secondary network can comprise a Multi-Universal Subscriber Identity Module (MUSIM) gap.

For the rest of time (i.e. during the time excluding the time windows for secondary network operations), the UE can stay connection with the primary network. During the period the UE stays connection with the primary network, various types of time windows can be configured for the UE to interact with the primary network or in other words, performing operations related to the primary networks, such as a time window for Layer-3 operation and a time window for Layer-1 operation. For example, the time window for Layer-3 operation can be a Synchronization Signal Block based radio resource management Measurement Timing Configuration (SMTC). For example, the time window for Layer-1 operation can comprise a time window for Radio Link Monitoring (RLM), a time window for Beam Failure Detection (BFD), a time window for Candidate Beam Discovery (CBD), a time window for Layer-1 Reference Signal Received Power (RSRP) measurement (based on Synchronization Signal Block (SSB) and/or Channel state information reference signal (CSI-RS)), and a time window for Layer-1 Signal-to-Noise and Interference Ratio (SINR) measurement (based on SSB and/or CSI-RS), etc. For example, each time of such time window for primary network operations can repeatedly appear (e.g. periodically or aperiodically). For example, in every type of time window for primary network operations, the UE can perform operation(s) related to the primary network same with or different from the operation(s) performed in another time window with a same type.

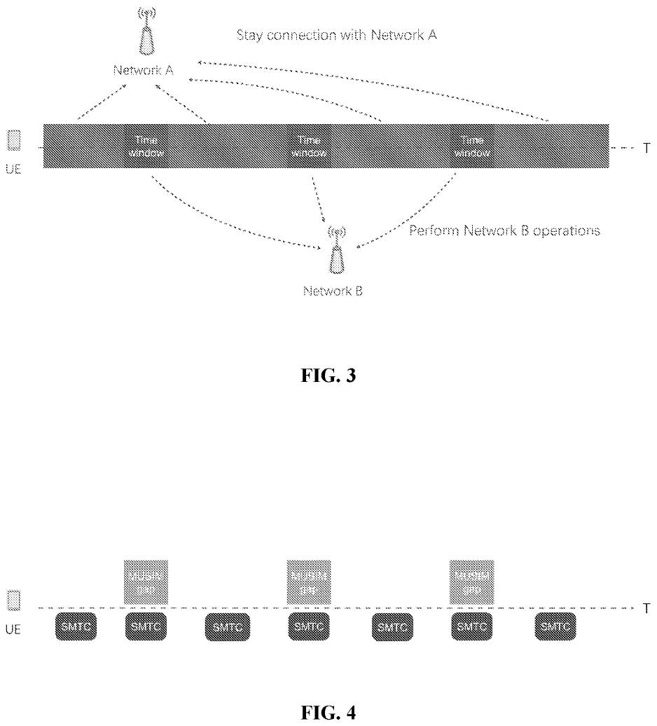

FIG. 3 illustrates an example operation configuration for a UE connected to two networks, i.e. Network A and Network B. Under the configuration example of FIG. 3, the UE stays connection with Network A most of the time and interactive with Network B within some specific time windows to perform operations related to Network B, such as RRM measurement, paging reception, system information (e.g. information regarding positioning under idle state) reception, etc. As explained above, although not shown in FIG. 3, during the period where the UE stays connection with Network A, various time windows can be configured of the UE to interact with Network A to perform corresponding operations. Note that although FIG. 3 illustrates the case that the UE is connected to two networks, the UE can be connected to more than two networks. To simplify explanation, the following will take the case of the UE being connected to two networks as an example to describe the present solution. However, the present solution can also apply to the cases where the UE is connected to more than two networks.

Since each of the time window for the primary network operation(s) and the time window for the secondary network operation(s) can repeatedly appear with a certain starting position (e.g. an offset), a certain length and/or a certain repetition cycle. It is possible that the time window for the primary network operation(s) collides with the time window for the primary network operation(s). FIG. 4 illustrates an example situation where time windows for performing operation(s) related to a first network collides with time windows for performing operation(s) related to a second network.

FIG. 4 shows collisions between particular time windows, i.e. SMTC and MUSIM gap. As known in the art, the SMTC is a periodically appeared time window during which the UE can perform RRM measurement (e.g. with the primary network, i.e. the first network in the case that the UE is connected to multiple networks). The MUSIM gap is a periodically appeared time window specifically configured for an MUSIM UE to perform operations related to a secondary network. As shown in FIG. 4, when an SMTC overlaps with an MUSIM gap in time, a collision between the SMTC and the MUSIM gap happens. In practice, each of the SMTC and the MUSIM gap can be configured with a certain starting position (e.g. an offset), a certain length and/or a certain repetition cycle. FIG. 4 shows an example configuration where the SMTC and the MUSIM gap share a same starting position and a same length but the repetition cycle of the MUSIM gap is twice as long as the repetition cycle of the SMTC. Therefore, in the case of FIG. 4, when the SMTC collides with the MUSIM gap, these two time windows are completely overlapped. However, more generally, the SMTC and the MUSIM gap may and may not aligned in terms of starting position, length, and/or repetition cycle. In general, two time windows can be considered as colliding with each other if the two time windows at least partially overlap with each other.

Note that although FIG. 4 illustrates the case that SMTCs collide with MUSIM gaps, the collision can happen for any other types of time windows, for example, between any Layer-3/Layer-1 time windows for Network A and any time window configured for a secondary network. To simplify explanation, the following will take the collision between SMTC and MUSIM gap as an example to describe the present solution. However, the present solution can also apply to any collision between time windows for a UE to perform operations(s) related to different networks.

When the collision between time windows for different networks happens, the occasions for performing operation(s) related to different networks collide with each other, which may cause communication failure with one or more of the multiple networks. Therefore, there is a need for a solution enabling the MUSIM UE to handle such a collision.

In general, the present invention provides a solution in which a UE can take repeatedly appeared first time windows as occasions to perform one or more first operations related to a first network; and can take repeatedly appeared second time windows as occasions to perform one or more second operations related to a second network different from the first network, and the UE can handle at least one collision between a first time window as an occasion to perform the one or more first operations within the first time window and a second time window as an occasion to perform the one or more second operations within the second time window by either dropping the occasion to perform the one or more first operations within the first time window or dropping the occasion to perform the one or more second operations within the second time window at least according to at least one sharing factor. According to the present disclosure, the at least one sharing factor can define a relationship between a number of dropped occasions to perform the one or more first operations and a number of dropped occasions to perform the one or more second operations. In other words, the at least one sharing factor may define a relationship between the number of skipped first time windows and the number of skipped second time windows.

As described above, there may be different types of first time windows, such as a time window for Layer-3 operation and a time window for Layer-1 operation. According to an implementation, for example, one sharing factor of the at one sharing factor may define the relationship between the number of skipped first time windows with a particular type and the number of skipped second time windows. Alternatively, for example, the sharing factor may define the relationship between the number of skipped first time windows with any type and the number of skipped second time windows in a unified way. According to the present disclosure, as will be detailly described below, the second time window may comprises multiple patterns. Accordingly, according to an implementation, one sharing factor of the at one sharing factor may define the relationship between the number of skipped first time windows with a particular type or any type and the number of skipped second time windows with a specific pattern. Alternatively, for example, the sharing factor may define the relationship between the number of skipped first time windows with a particular type or any type and the number of skipped second time windows with any pattern in a unified way.

For simplicity of description, hereinafter, the term “first time window” refers to the time window to be taken by the UE as the occasion to perform one or more first operations related to a first network. The term “second time window” refers to the time window to be taken by the UE as the occasion to perform one or more second operations related to a second network. The term “first operation” refers to the operation related to the first network, and the term “second operation” refers to the operation related to the second network.

As described above, the present disclosure may also apply to the case where the UE is connected to more than two networks. In this case, the UE can handle the collision among time windows for different networks according to at least one sharing factor defining a relationship among numbers of dropped occasions to perform one or more operations related to respective networks.

For example, the relationship defined by the at least one sharing factor may be a ratio relationship between the number of dropped occasions to perform the one or more first operations and the number of dropped occasions to perform the one or more second operations. For example, if the UE is connected to two networks, the relationship may define that every k collisions between first time windows and second time windows, the wireless device shall drop m occasions to perform the one or more first operations and drop n occasions to perform the one or more second operations, where, each of m and n is an integer equal to or larger than 0, and k is equal to a sum of n and m. In other words, every k collisions between first time windows and second time windows, the UE may skip m first time windows and skip n second time window.

In practice, the configuration of the first and second time windows (e.g. starting position, length, and/or repetition cycle) is known by the UE in advance. Therefore, the UE can predict when the collision between a first time window and a second time window will happen, and handle the coming collision by either dropping the occasion to perform the first operation(s) or dropping the occasion to perform the second operation(s) according to the sharing factor defining the above explained relationship.

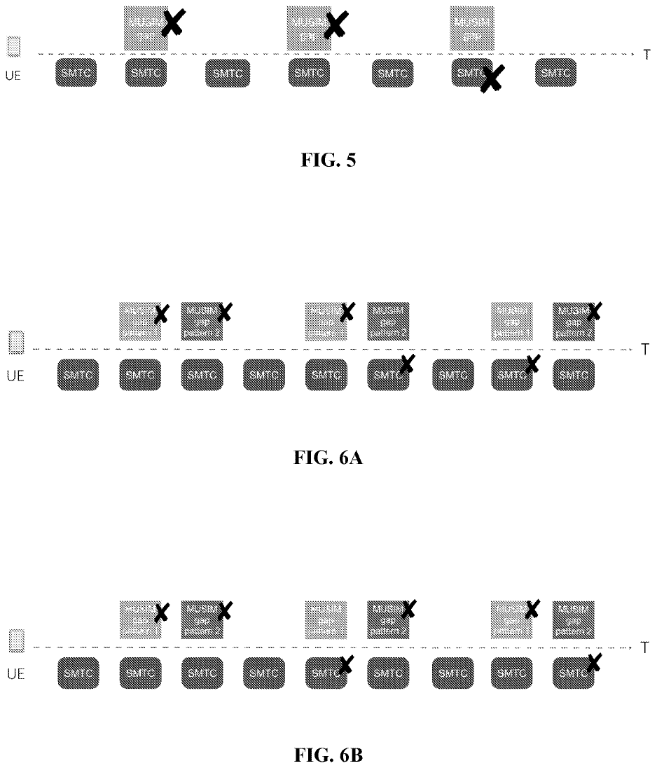

FIG. 5 illustrates an example solution to address the collision between first time windows for the first network operations and second time windows for the second network operations according to an embodiment of the present disclosure. Similar to FIG. 4, FIG. 5 takes the collision between SMTC and MUSIM gap as an example. However, the present disclosure applies to the collision between any suitable types of time windows for different networks. Under the case of FIG. 5, the sharing factor may define that the ratio between the number of dropped occasions to perform the one or more first operations within SMTCs and the number of dropped occasions to perform the one or more second operations within MUSIM gaps is 1:2. In other words, the sharing factor may define that every three collisions between SMTCs and MUSIM gaps, the UE shall drop one occasion to perform the one or more first operations (i.e. skip one SMTC) and drop two occasions to perform the one or more second operations (i.e. skip two MUSIM gaps). According to such a sharing factor, as shown in FIG. 5, every three collisions between SMTCs and MUSIM gaps, two MUSIM gaps and one SMTC are skipped. In other words, every three collisions between SMTCs and MUSIM gaps, two occasions to perform the second operation(s) related to the second network are dropped and one occasion to perform the first operation(s) related to the first network is dropped.

As shown in FIG. 5, for the illustrated three collisions, the first two MUSIM gaps are skipped and the last SMTC is skipped. However, in practice, the UE can choose any time window to skip as long as the skipped time window(s) satisfies the relationship defined by the sharing factor. For example, for the illustrated three collisions in FIG. 5, the first MUSIM gap, the last MUSIM gap and the second SMTC can be skipped. Alternatively, the first SMTC and the last two MUSIM gaps can be skipped. Besides, the UE does not have to follow a unified mode to skip the time windows for every k collisions. For example, in the case of FIG. 5, for the first three collisions, the UE can skip the first two MUSIM gaps and the last SMTC, and for the next three collisions, the UE can follow another mode to skip time window, e.g. skip the first SMTC and the last two MUSIM gaps. In practice, the UE can determine which of the time windows for a group of k collisions is to be skipped by itself, as long as in general, every k collisions between first time windows and second time windows, m time windows related to the first network are skipped and n time windows related to the second network are skipped, where, each of m and n is an integer equal to or larger than 0, and k is equal to a sum of n and m.

According to the present disclosure, the relationship defined by the sharing factor can be any ratio between the number of dropped occasions to perform the one or more first operations and the number of dropped occasions to perform the one or more second operations, such as 1:1, 1:2, 1:3, 2:3, etc. Particularly, the relationship can also comprise some absolute prioritization. For example, the sharing factor can indicate that the second time window is always prioritized over the first time window. Accordingly, the occasion to perform the one or more first operations can always be dropped in the case that the collision between a first time window and a second time window happens. In other words, the UE can always perform the second operation(s) related to the second network and skip the first time window related to the first network in the case of collision. For another example, the sharing factor can indicate that the first time window is always prioritized over the second time window. Accordingly, the occasion to perform the one or more second operations can always be dropped in the case that the collision between a first time window and a second time window happens. In other words, the UE can always perform the first operation(s) related to the first network and skip the second time window related to the second network in the case of collision.

According to the present disclosure, the second time window for the UE to perform operation(s) related to the second network may comprise a plurality of patterns. Each pattern of second time window can be configured with a certain starting position (e.g. an offset), a certain length and/or a certain repetition cycle. According to the present disclosure, the UE can handle the collisions between first time windows and second time windows with various patterns by either treating the second time windows with different patterns separately or in a unified way.

Particularly, according to one implementation of the present disclosure, the UE can handle at least one collision between a first time window and a second time window according to a plurality of sharing factors each defining a relationship between the number of dropped occasions to perform the one or more first operations within first time windows and a number of dropped occasions to perform the one or more second operations within second time windows with a specific pattern.

FIG. 6A illustrates an example solution to address the collision between first time windows for the first network operations and second time windows with a plurality of patterns for the second network operations according to an embodiment of the present disclosure. Similar to FIG. 4 and FIG. 5, FIG. 6A takes the collision between SMTC and MUSIM gap as an example. However, the present disclosure applies to the collision between any suitable types of time windows for different networks. As shown in FIG. 6A, two patters for the second time window are involved. The UE can handle the collisions between first time windows and second time windows with different patterns according to two sharing factor, i.e. a first sharing factor defining a relationship between the number of dropped occasions to perform the one or more first operations within first time windows (e.g. SMTC as shown in FIG. 6A) and the number of dropped occasions to perform the one or more second operations within second time windows with pattern 1 (e.g. MUSIM gap with pattern 1 as shown in FIG. 6A), and a second sharing factor defining a relationship between the number of dropped occasions to perform the one or more first operations within first time windows (e.g. SMTC as shown in FIG. 6A) and the number of dropped occasions to perform the one or more second operations within second time windows with pattern 2 (e.g. MUSIM gap with pattern 2 as shown in FIG. 6A). In other words, the first sharing factor may define a relationship between the number of skipped first time windows and the number of skipped second time windows with pattern 1, and the second sharing factor may define a relationship between the number of skipped first time windows and the number of skipped second time windows with pattern 2.

As shown in FIG. 6A, the first sharing factor may define that the ratio between the number of dropped occasions to perform the one or more first operations within SMTCs and the number of dropped occasions to perform the one or more second operations within MUSIM gaps with pattern 1 is 1:2. Therefore, as shown in FIG. 6A, every three collisions between SMTCs and MUSIM gaps with pattern 1, two MUSIM gaps with pattern 1 and one SMTC is skipped. As shown in FIG. 6A, the second sharing factor may define that the ratio between the number of dropped occasions to perform the one or more first operations within SMTCs and the number of dropped occasions to perform the one or more second operations within MUSIM gaps with pattern 2 is 1:1. Therefore, as shown in FIG. 6A, every two collisions between SMTCs and MUSIM gaps with pattern 2, one MUSIM gap with pattern 2 and one SMTC are skipped.

In practice, for example, different patterns of second time window can be configured for the UE to perform different types of second operation. Accordingly, the value (e.g. representing the ratio between the number of skipped first time window and the number of skipped second time window, or the priority of the performance of the first operation(s) and the second operation(s)) of each of the plurality of sharing factors may depend on the type of the one or more second operations to be performed within a second time window with a corresponding pattern. According to the present disclosure, the value of each of the plurality of sharing factors can be configured by the gNB or can be predefined for each pattern of second time window in a fixed way (e.g. predefined in the related 3GPP specification) For example, the gNB can configure three patterns of second time window among which a first one is for the UE to perform operation(s) related to RRM measurement, a second one is for the UE to perform operation(s) related to system information reception and a third one is for the UE to perform operation(s) related to paging reception. For example, based on the severity of consequence caused by failing to perform corresponding operation(s), different values can be configured/defined for the three patterns. For example, for the first pattern (i.e. the pattern related to system information reception), the corresponding sharing factor can be configured/pre-defined with a value representing that the performance of the first operation(s) has a higher priority than the performance of the second operation(s). For another example, for the second or third pattern (e.g. the pattern related to paging reception or RRM measurement), the corresponding sharing factor can be configured/pre-defined with a value representing that the performance of the first operation(s) related to the first network has a lower priority than the performance of the second operation(s) related to the second network.

According to one implementation of the present disclosure, the UE can handle at least one collision between a first time window and a second time window according to one single sharing factor defining a relationship between the number of dropped occasions to perform the one or more first operations within first time windows and a number of dropped occasions to perform the one or more second operations within second time windows with any pattern. In this case, the different patterns of second time windows are considered in a unified way.

FIG. 6B illustrates an example solution to address the collision between first time windows for the first network operations and second time windows with a plurality of patterns for the second network operations according to such implementation of the present disclosure. As shown in FIG. 6B, two patters for the second time window are involved. The UE can handle the collisions between first time windows and second time windows with different patterns according to a single sharing factor defining a relationship between the number of dropped occasions to perform the one or more first operations within first time windows (e.g. SMTC as shown in FIG. 6B) and the number of dropped occasions to perform the one or more second operations within second time windows with any pattern (e.g. MUSIM gap with pattern 1 or pattern 2 as shown in FIG. 6B). In other words, the sharing factor may define a relationship between the number of skipped first time windows and the number of skipped second time windows with any pattern.

As shown in FIG. 6B, the sharing factor may define that the ratio between the number of dropped occasions to perform the one or more first operations within SMTCs and the number of dropped occasions to perform the one or more second operations within MUSIM gaps with any pattern (i.e. pattern 1 or pattern 2) is 1:2. Therefore, as shown in FIG. 6A, every three collisions between SMTCs and MUSIM gaps with pattern 1 or pattern 2, two MUSIM gaps with pattern 1 or pattern 2 and one SMTC are skipped. That is, as shown in FIG. 6B, every three collisions between SMTCs and MUSIM gaps with any pattern, two MUSIM gaps with any pattern and one SMTC are skipped.

The at least one sharing factor of the present disclosure has been described in detail above. According to the present disclosure, the at least one sharing factor can be indicated by the gNB, or can be pre-defined.

According to an embodiment of the present disclosure, the at least one sharing factor can be indicated by the gNB via a Radio Resource Control (RRC) message. According to an implementation, the RRC message can comprise the value of each of the at least one sharing factor. For example, the value may be a digital value reflecting the ratio relationship between the number of dropped occasions to perform the one or more first operations and the number of dropped occasions to perform the one or more second operations. In this case, some special digital value can be defined to indicate the absolute prioritization. For example, the sharing factor with the value 0 can represent that the performance of the first operation(s) in the first time window is always prioritized over the performance of the second operation(s) in the second time window. That is, the occasion to perform the one or more second operation in the second time window is always dropped in the case that the collision between a first time window and a second time window happens. For another example, the sharing factor with a very large value (e.g. 100) can represent that the performance of the second operation(s) in the second time window is always prioritized over the performance of the first operation(s) in the first time window. That is, the occasion to perform the one or more first operation in the first time window is always dropped in the case that the collision between a first time window and a second time window happens. In the case that the second time window is configured with a plurality of patterns, the gNB can configure a specific sharing factor for each pattern of the second time window and transmit the RRC message comprising the respective value of each of the plurality of sharing factors to the UE.

According to a preferred implementation, the RRC message can comprise an identifier of each of the at least one sharing factor. In this case, the UE can determine the value of each of the at least one sharing factor based on a pre-defined relationship between an identifier of the sharing factor and a respective value of the sharing factor. For example, such a relationship can be defined in the related 3GPP specification. For example, the identifiers scheme0 to schemeN (N can be an integer digit larger than 0) can be pre-defined in the related 3GPP specification. For example, scheme0 can correspond to the case that the performance of the second operation(s) within the second time window is always prioritized over the performance of the first operation(s) within the first time window, schemeN can correspond to the case that the performance of the first operation(s) within the first time window is always prioritized over the performance of the second operation(s) within the second time window, schemel can correspond to the ratio 1:1 between the number of dropped occasions to perform the first operation(s) and the number of dropped occasions to perform the second operation(s), and scheme 2 can correspond to the ratio 1:2 between the number of dropped occasions to perform the first operation(s) and the number of dropped occasions to perform the second operation(s), etc.

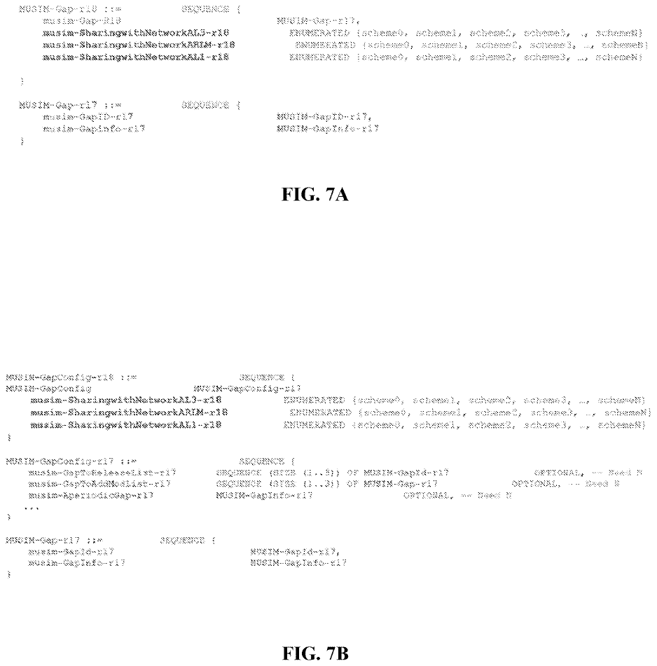

FIG. 7A illustrates an example RRC message indicating the at least one sharing factor according to the preferred implementation. In the example RRC message of FIG. 7A, three sharing factors are defined for one MUSIM gap with a specific pattern, i.e. the sharing factor “musim-SharingwithNetworkAL3-r18” defined for addressing the collision between the first time window for Layer-3 operation and the MUSIM gap with the specific pattern, the sharing factor “musim-SharingwithNetworkARLM-r18” defined for addressing the collision between the first time window for RLM and the MUSIM gap with the specific pattern, and the sharing factor “musim-SharingwithNetworkAL1-r18” defined for addressing the collision between the first time window for Layer-1 operation and the MUSIM gap with the specific pattern. For each sharing factor, the RRC message comprises an identifier selected from scheme0 to schemeN. After receiving such an RRC message, the UE can determine the value of each sharing factor based on a pre-defined relationship between an identifier of the sharing factor and a respective value of the sharing factor pre-defined in the related 3GPP specification, for example.

FIG. 7B illustrates another example RRC message indicating the at least one sharing factor according to the preferred implementation. Different from the example of FIG. 7A, in the example RRC message of FIG. 7A, the three sharing factors are defined in a unified way for an MUSIM gap with any pattern, i.e. the sharing factor “musim-SharingwithNetworkAL3-r18” defined for addressing the collision between the first time window for Layer-3 operation and the MUSIM gap with any pattern, the sharing factor “musim-SharingwithNetworkARLM-r18” defined for addressing the collision between the first time window for RLM and the MUSIM gap with any pattern, and the sharing factor “musim-SharingwithNetworkAL1-r18” defined for addressing the collision between the first time window for Layer-1 operation and the MUSIM gap with any pattern. Similar to the example of FIG. 7A, for each sharing factor, the RRC message comprises an identifier selected from scheme0 to schemeN. After receiving such an RRC message, the UE can determine the value of each sharing factor based on a pre-defined relationship between an identifier of the sharing factor and a respective value of the sharing factor pre-defined in the related 3GPP specification, for example.

According to an embodiment of the present disclosure, the at least one sharing factor can be pre-defined, e.g. in the related 3GPP specification. For example, different sharing factors can be pre-defined, such as sharing factors for addressing the collision between each type of first time window and each pattern of second time window. For another example, the sharing factors can be pre-defined in larger granularity, e.g. each sharing factor may be defined for addressing the collision between each type of first time window and a second time window with any pattern. For anther example, the sharing factor may be defined in a more general way, e.g. merely defining a sharing factor indicating that the performance of the second operation(s) is always prioritized over the performance of the first operation(s).

The above has detailly described handling at least one collision between a first time window as an occasion to perform the first operation(s) and a second time window as an occasion to perform the second operation(s) according to the at least one sharing factor. In some cases, the operation(s) to be performed in the first time window related to the first network may concern some critical procedure and shall not be impacted by any second time window.

To address such exceptional cases, according to an embodiment of the present disclosure, the UE can handle the at least one collision by either dropping the occasion to perform the one or more first operations within the first time window or dropping the occasion to perform the one or more second operations within the second time window further according to one or more pre-defined rules. The one or more pre-defined rules may indicate the UE to drop the one or more second operations within the second time window in the case that the one or more first operations relate to one or more aperiodic events. For example, the one or more aperiodic events may comprise any one or more of transmission of Message (Msg) 1 to Msg 5 during a Random Access Channel (RACH) procedure, and first valid Channel Quality Indicator (CQI) feedback in Secondary Cell (SCell) activation (e.g. such that the first network knows the SCell is ready for scheduling), etc. For example, such rule(s) can be pre-defined in the related 3GPP specification.

To address such exceptional cases, according to another embodiment of the present disclosure, the gNB can aperiodically trigger the skip of one or more second time windows. Particularly, before the critical procedure begins, the gNB can transmit an instruction to the UE indicating that the UE shall drop at least one coming occasion to perform the one or more second operations within at least one second time window in the case that at least one collision between first time window(s) and second time window(s) happens. In other words, such an instruction may indicate the UE to drop x coming occasion(s) to perform the one or more second operation(s) for future x collision(s) between first time window(s) and second time window(s), where, x can be an integer equal to or larger than 1. For example, such an instruction can be aperiodically transmitted and can be transmitted via any suitable signaling/message such as Downlink Control Information (DCI) or Medium Access Control Control Element (MAC CE). Following to the instruction, the UE can handle the collision(s) by dropping the at least one instructed occasion. For example, the number of the at least one coming occasion to be dropped can be pre-defined (e.g. in the related 3GPP specification) or configurable (e.g. indicated via a signaling/message which is the same as or different from the signaling/message used for transmitting the instruction).

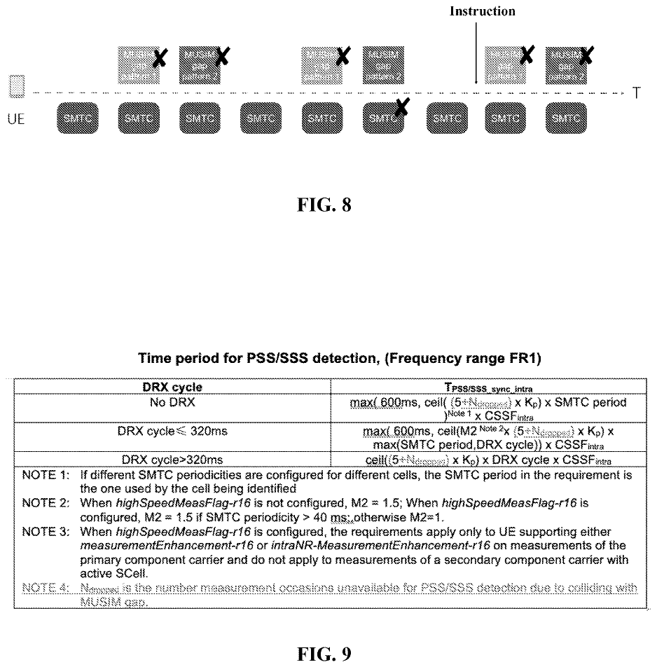

FIG. 8 illustrates an example of aperiodic triggered second time window(s) skip. Despite the instruction, the UE in FIG. 8 basically takes the same way to handle the collisions between the SMTCs and the MUSIM gaps with pattern 1 or pattern 2 as FIG. 6A. In the example of FIG. 8, the instruction transmitted from the gNB may indicate the UE to drop the coming one occasion to perform the first operation(s) within the MUSIM gap with any pattern if the collision between the SMTC and the MUSIM gap happens. Following to such an instruction, instead of skipping the SMTC as shown in FIG. 6A, the UE skips the MUSIM gap with pattern 1 collided with the SMTC and performs the first operation(s) in the SMTC.

According to an embodiment of the present disclosure, the eNB can also transmit (e.g. aperiodically) an instruction to the UE indicating that the UE shall drop at least one coming occasion to perform the one or more first operations within at least one first time window in the case that at least one collision between first time window(s) and second time window(s) happens, so as to avoid impacting any critical procedure in the second network. In other words, such an instruction may indicate the UE to drop x coming occasion(s) to perform the one or more first operation(s) for future x collision(s) between first time window(s) and second time window(s), where, x can be an integer equal to or larger than 1.

According to the present disclosure, the collisions are handled by either dropping the occasion(s) to perform the first operation(s) within the first time window(s) or dropping the occasion(s) to perform the second operation(s) within the second time window(s). Therefore, the latency of the first/second operation(s) may be increased due to the dropped occasion(s). For example, the latency for performing RRM procedure in the first network may be increased to adapt to the lost occasion(s) to perform the operation(s) related to the RRM procedure in the first network due to the collision(s).

According to the present disclosure, for example, the UE can perform RRM procedure according to an increased latency in the case that at least one occasion to perform the one or more first operations is dropped due to at least one collision between a first time window and a second time window. For example, the increased amount of time can be determined by the UE or by the gNB based on actual situation. In this case, there may be no fixed limit for the latency to be extend.

For another example, the latency can be increased according to a count of the dropped occasions to perform the one or more first operations due to the at least one collision. In this case, both the UE and the gNB can calculate the length of the extended latency based on the count of the dropped occasions. FIG. 9 illustrates an example of increased latency for Primary synchronization signal (PSS)/Secondary synchronization signal (SSS) detection in FRI as a type RRM procedure. As shown in FIG. 9, the time period for PSS/SSS detection can be increased based on the number of measurement occasions unavailable (i.e. number of dropped occasions for performing measurement within SMTCs) for PSS/SSS detection due to the collision between SMTCs and MUSIM gaps.

The details of the present disclosure have been described above especially taken the example of collision between an SMTC for the first network operations and an MUSIM gap for the second network operations. However, such exemplary description shall not be considered as limited. For example, the UE can handle the collisions between any types of first time windows (e.g. as described above, any time window for Layer-1 operation or any time window for Layer-3 operation) and any types of second time windows (e.g. any time window configured for secondary network operations other than MUSIM gap) using the spirit of the present disclosure as detailly described above. Further, the UE can also handle collisions among time windows for more than two networks using the spirit of the present disclosure as detailly described above. For example, the UE can also handle collisions among time windows for more than two networks according to at least one sharing factor defining the relationship of the numbers of skipped time windows for respective networks.

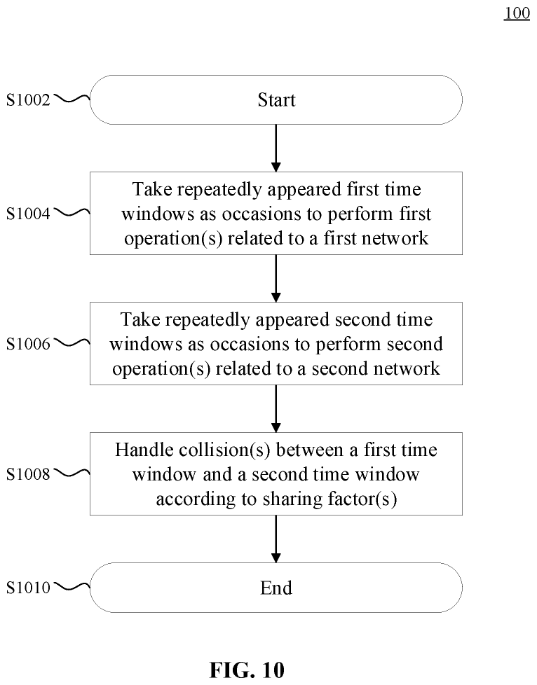

FIG. 10 is a flow diagram illustrating an example method 100 for addressing collisions among time windows for operations related to different networks for a wireless device (e.g. a UE).

The method starts at S1002.

At S1004, the wireless device may take repeatedly appeared first time windows as occasions to perform one or more first operations related to a first network.

At S1006, the wireless device may take repeatedly appeared second time windows as occasions to perform one or more second operations related to a second network different from the first network.

At S1008, the wireless device may handle at least one collision between a first time window as an occasion to perform the one or more first operations within the first time window and a second time window as an occasion to perform the one or more second operations within the second time window by either dropping the occasion to perform the one or more first operations within the first time window or dropping the occasion to perform the one or more second operations within the second time window at least according to at least one sharing factor. The at least one sharing factor may define a relationship between a number of dropped occasions to perform the one or more first operations and a number of dropped occasions to perform the one or more second operations.

The method ends at S1010.

Note that the operations shown in FIG. 10 are only for the purpose of illustration without any limitation. The example implementation details of the operations have been described above. The operation flow of the wireless device can comprise any one or more additional operations as described above. Besides, the operations do not have to be performed according to the sequence shown in FIG. 10. For example, S1004 and S1006 may be performed simultaneously or nearly simultaneously, and S1004 and S1006 can be continually performed while handling the collision by performing the operations of S1008.

Embodiments contemplated herein include an apparatus comprising means to perform one or more elements of the method for addressing collisions among time windows for operations related to different networks. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method for addressing collisions among time windows for operations related to different networks. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method for addressing collisions among time windows for operations related to different networks. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method for addressing collisions among time windows for operations related to different networks. This apparatus may be, for example, an apparatus of a UE (such as a wireless device 202 that is a UE, as described herein).

Embodiments contemplated herein include a signal as described in or related to one or more elements of the method for addressing collisions among time windows for operations related to different networks.

Embodiments contemplated herein include a computer program or computer program product comprising instructions, wherein execution of the program by a processor is to cause the processor to carry out one or more elements of the method for addressing collisions among time windows for operations related to different networks. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

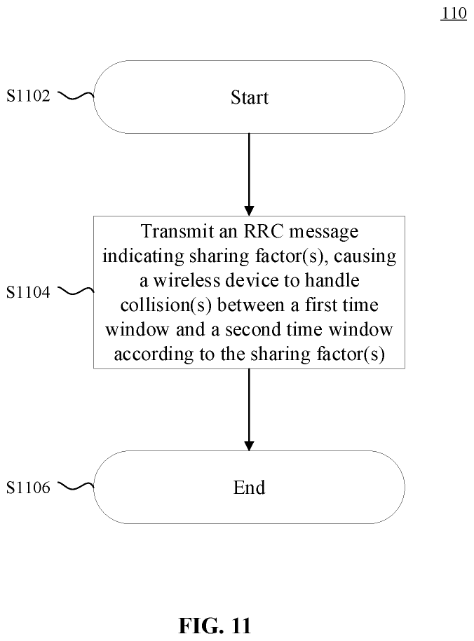

FIG. 11 is a flow diagram illustrating an example method 110 for addressing collisions among time windows for operations related to different networks for a network device (e.g., a gNB of one of the networks).

The method starts at S1102.

At S1104, the network device may transmit an RRC message indicating at least one sharing factor causing the wireless device to handle at least one collision between a first time window as an occasion to perform one or more first operations related to a first network within the first time window and a second time window as an occasion to perform one or more second operations related to a second network within the second time window by either dropping the occasion to perform the one or more first operations within the first time window or dropping the occasion to perform the one or more second operations within the second time window at least according to the at least one sharing factor, a plurality of the first time windows may appear repeatedly as occasions for the wireless device to perform the one or more first operations, and a plurality of the second time windows may appear repeatedly as occasions for the wireless device to perform the one or more second operations. The at least one sharing factor may define a relationship between a number of dropped occasions to perform the one or more first operations and a number of dropped occasions to perform the one or more second operations.

The method ends at S1106.

Note that the operations shown in FIG. 10 are only for the purpose of illustration without any limitation. The example implementation details of the operations have been described above. The operation flow of the wireless device can comprise any one or more additional operations as described above.

Embodiments contemplated herein include an apparatus comprising means to perform one or more elements of the method for addressing collisions among time windows for operations related to different networks. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method for addressing collisions among time windows for operations related to different networks. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method for addressing collisions among time windows for operations related to different networks. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method for addressing collisions among time windows for operations related to different networks. This apparatus may be, for example, an apparatus of a base station (such as a network device 218 that is a base station, as described herein).

Embodiments contemplated herein include a signal as described in or related to one or more elements of the method for addressing collisions among time windows for operations related to different networks.

Embodiments contemplated herein include a computer program or computer program product comprising instructions, wherein execution of the program by a processing element is to cause the processing element to carry out one or more elements of the method or addressing collisions among time windows for operations related to different networks. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

Various aspects of the present disclosure have been described above. The present disclosure can be realized in various embodiments.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

The above has described in detail the solution for addressing collisions among time windows for operations related to different networks. With the present solution, advantageous, the UE is able to handle the collision among time windows for different networks properly. Besides, some exceptional situations are specially treated such that some critical procedures would not be impacted due to the skip of time windows caused by the collisions. In addition, the present disclosure can also have any of the configurations below.
(1) A wireless device, comprising:
   at least one antenna;
   at least one radio coupled to the at least one antenna; and
   a processor coupled to the at least one radio;
   wherein the processor is configured to
      take repeatedly appeared first time windows as occasions to perform one or more first operations related to a first network; and
      take repeatedly appeared second time windows as occasions to perform one or more second operations related to a second network different from the first network,
   wherein the processor is further configured to handle at least one collision between a first time window as an occasion to perform the one or more first operations within the first time window and a second time window as an occasion to perform the one or more second operations within the second time window by either dropping the occasion to perform the one or more first operations within the first time window or dropping the occasion to perform the one or more second operations within the second time window at least according to at least one sharing factor, the at least one sharing factor defines a relationship between a number of dropped occasions to perform the one or more first operations and a number of dropped occasions to perform the one or more second operations.
(2) The wireless device of (1), wherein
   the processor is further configured to receive, via the at least one radio from a cellular base station, a Radio Resource Control (RRC) message indicating the at least one sharing factor.
(3) The wireless device of (2), wherein
   a value of each of the at least one sharing factor is comprised in the RRC message, or
   an identifier of each of the at least one sharing factor is comprised in the RRC message, and the processor is further configured to determine the value of each of the at least one sharing factor based on a pre-defined relationship between an identifier of the sharing factor and a respective value of the sharing factor.
(4) The wireless device of any of (1)-(3), wherein the relationship defines that every k collisions between first time windows and second time windows, the wireless device shall drop m occasions to perform the one or more first operations and drop n occasions to perform the one or more second operations, wherein, each of m and n is an integer equal to or larger than 0, and k is equal to a sum of n and m.
(5) The wireless device of (4), wherein the relationship further defines the following absolute prioritization:
   the occasion to perform the one or more first operations is always dropped in the case that the collision between a first time window and a second time window happens, and
   the occasion to perform the one or more second operation in the second time window is always dropped in the case that the collision between a first time window and a second time window happens.
(6) The wireless device of any of (1)-(3), wherein the first time window is a time window for Layer-3 operation or a time window for Layer-1 operation.
(7) The wireless device of (6), wherein the time window for Layer-3 operation is a Synchronization Signal Block based radio resource management Measurement Timing Configuration (SMTC).
(8) The wireless device of (6), wherein the time window for Layer-1 operation at least comprises any of a time window for Radio Link Monitoring (RLM), a time window for Beam Failure Detection (BFD), a time window for Candidate Beam Discovery (CBD), a time window for Layer-1 Reference Signal Received Power (RSRP) measurement, and a time window for Layer-1 Signal-to-Noise and Interference Ratio (SINR) measurement.
(9) The wireless device of (1),
   wherein, the second time window comprises a plurality of patterns, and
   wherein the processor is further configured to handle said at least one collision according to a plurality of sharing factors each defining a relationship between the number of dropped occasions to perform the one or more first operations within first time windows and a number of dropped occasions to perform the one or more second operations within second time windows with a specific pattern.
(10) The wireless device of (9), wherein the value of each of the plurality of sharing factors depends on a type of the one or more second operations to be performed within a second time window with a corresponding pattern.
(11) The wireless device of (9),
   wherein, the second time window comprises a plurality of patterns, and
   wherein the processor is further configured to handle said at least one collision according to one single sharing factor defining a relationship between the number of dropped occasions to perform the one or more first operations within first time windows and a number of dropped occasions to perform the one or more second operations within second time windows with any pattern.
(12) The wireless device of any of (9)-(11), wherein the second time window is a Multi-Universal Subscriber Identity Module (MUSIM) gap.
(13) The wireless device of any of (1)-(3), wherein
   the processor is further configured to handle said at least one collision by either dropping the occasion to perform the one or more first operations within the first time window or dropping the occasion to perform the one or more second operations within the second time window according to one or more pre-defined rules,
   wherein the one or more pre-defined rules indicating the wireless device to drop the one or more second operations within the second time window in the case that the one or more first operations relate to one or more aperiodic events.
(14) The wireless device of (13), wherein the one or more aperiodic events at least comprise any one or more of transmission of Message (Msg) 1 to Msg 5 during a Random Access Channel (RACH) procedure, and first valid Channel Quality Indicator (CQI) feedback in Secondary Cell (SCell) activation.
(15) The wireless device of any of (1)-(3), wherein the processor is further configured to
   receive, via the at least one radio an instruction from a cellular base station, an instruction indicating to either drop at least one coming occasion to perform the one or more first operations within at least one first time window or drop at least one coming occasion to perform the one or more second operations within at least one second time window in the case that at least one collision between the at least one first time window and the at least one second time window happens, wherein, the number of the at least one coming occasion to be dropped is pre-defined or configurable, and
   handle the at least one collision by dropping the at least one instructed occasion,
   wherein, the instruction is aperiodically transmitted.
(16) The wireless device of (15), wherein the instruction is transmitted via Downlink Control Information (DCI) or Medium Access Control Control Element (MAC CE).
(17) The wireless device of any of (1)-(3), wherein the processor is further configured to perform Radio Resource Management (RRM) procedure according to an increased latency in the case that at least one occasion to perform the one or more first operations is dropped due to said at least one collision.
(18) The wireless device of (17), wherein the latency is increased according to a count of the dropped occasions to perform the one or more first operations due to said at least one collision.
(19) The wireless device of any of (1)-(3), wherein the at least one sharing factor is pre-defined.
(20) A cellular base station, comprising:
   at least one antenna;
   at least one radio coupled to the at least one antenna; and
   a processor coupled to the at least one radio;
   wherein the processor is configured to:
      transmit, via the at least one radio to a wireless device, a Radio Resource Control (RRC) message indicating at least one sharing factor causing the wireless device to handle at least one collision between a first time window as an occasion to perform one or more first operations related to a first network within the first time window and a second time window as an occasion to perform one or more second operations related to a second network within the second time window by either dropping the occasion to perform the one or more first operations within the first time window or dropping the occasion to perform the one or more second operations within the second time window at least according to the at least one sharing factor, a plurality of said first time windows appear repeatedly as occasions for the wireless device to perform said one or more first operations, and a plurality of said second time windows appear repeatedly as occasions for the wireless device to perform said one or more second operations,
   wherein the at least one sharing factor defines a relationship between a number of dropped occasions to perform the one or more first operations and a number of dropped occasions to perform the one or more second operations.
(21) The cellular base station of (20), wherein
   a value of each of the at least one sharing factor is comprised in the RRC message, or
   an identifier of each of the at least one sharing factor is comprised in the RRC message.
(22) The cellular base station of (20),
   wherein the second time window comprises a plurality of patterns, and
   wherein the processor is configured to:
      transmit, via the at least one radio to the wireless device, the RRC message indicating a plurality of sharing factors each defining a relationship between the number of dropped occasions to perform the one or more first operations within first time windows and a number of dropped occasions to perform the one or more second operations within second time windows with a specific pattern.
(23) The cellular base station of (20),
   wherein the second time window comprises a plurality of patterns, and
   wherein the processor is configured to:
      transmit, via the at least one radio to the wireless device, the RRC message indicating one single sharing factor defining a relationship between the number of dropped occasions to perform the one or more first operations within first time windows and a number of dropped occasions to perform the one or more second operations within second time windows with any pattern.
(24) The cellular base station of (22) or (23), wherein the second time window is a Multi-Universal Subscriber Identity Module (MUSIM) gap.
(25) The cellular base station of (20) or (21), wherein the processor is further configured to
   transmit, via the at least one radio an instruction to the wireless device, an instruction indicating the wireless device to either drop at least one coming occasion to perform the one or more first operations within at least one first time window or drop at least one coming occasion to perform the one or more second operations within at least one second time window in the case that at least one collision between the at least one first time window and the at least one second time window happens, wherein, the number of the at least one coming occasion to be dropped is pre-defined or configurable, and wherein the instruction is aperiodically transmitted.
(26) The cellular base station of (25), the instruction is transmitted via Downlink Control Information (DCI) or Medium Access Control Control Element (MAC CE).
(27) A method for a wireless device, comprising:
   taking repeatedly appeared first time windows as occasions to perform one or more first operations related to a first network; and
   taking repeatedly appeared second time windows as occasions to perform one or more second operations related to a second network different from the first network,
   wherein the method further comprising handling at least one collision between a first time window as an occasion to perform the one or more first operations within the first time window and a second time window as an occasion to perform the one or more second operations within the second time window by either dropping the occasion to perform the one or more first operations within the first time window or dropping the occasion to perform the one or more second operations within the second time window at least according to at least one sharing factor, the at least one sharing factor defines a relationship between a number of dropped occasions to perform the one or more first operations and a number of dropped occasions to perform the one or more second operations.
(28) A method for a cellular base station, comprising:
   transmitting, via the at least one radio to a wireless device, a Radio Resource Control (RRC) message indicating at least one sharing factor causing the wireless device to handle at least one collision between a first time window as an occasion to perform one or more first operations related to a first network within the first time window and a second time window as an occasion to perform one or more second operations related to a second network within the second time window by either dropping the occasion to perform the one or more first operations within the first time window or dropping the occasion to perform the one or more second operations within the second time window at least according to the at least one sharing factor, a plurality of said first time windows appearing repeatedly as occasions for the wireless device to perform said one or more first operations, and a plurality of said second time windows appearing repeatedly as occasions for the wireless device to perform said one or more second operations, wherein the at least one sharing factor defines a relationship between a number of dropped occasions to perform the one or more first operations and a number of dropped occasions to perform the one or more second operations.
(29) An apparatus, comprising:
   a processor configured to cause a wireless device to:
      take repeatedly appeared first time windows as occasions to perform one or more first operations related to a first network; and
      take repeatedly appeared second time windows as occasions to perform one or more second operations related to a second network different from the first network,
   wherein the processor is further configured to handle at least one collision between a first time window as an occasion to perform the one or more first operations within the first time window and a second time window as an occasion to perform the one or more second operations within the second time window by either dropping the occasion to perform the one or more first operations within the first time window or dropping the occasion to perform the one or more second operations within the second time window at least according to at least one sharing factor, the at least one sharing factor defines a relationship between a number of dropped occasions to perform the one or more first operations and a number of dropped occasions to perform the one or more second operations.
(30) A computer-readable storage medium storing program instructions, wherein the program instructions, when executed by a computer system, cause the computer system to perform the method of (27).
(31) A computer-readable storage medium storing program instructions, wherein the program instructions, when executed by a computer system, cause the computer system to perform the method of (28).
(32) A computer program product, comprising program instructions which, when executed by a computer, cause the computer to perform the method of (27).
(33) A computer program product, comprising program instructions which, when executed by a computer, cause the computer to perform the method of (28).

1. A wireless device, comprising:
at least one antenna;
at least one radio coupled to the at least one antenna; and
a processor coupled to the at least one radio;
wherein the processor is configured to
take repeatedly appeared first time windows as occasions to perform one or more first operations related to a first network; and
take repeatedly appeared second time windows as occasions to perform one or more second operations related to a second network different from the first network,
wherein the processor is further configured to handle at least one collision between a first time window as an occasion to perform the one or more first operations within the first time window and a second time window as an occasion to perform the one or more second operations within the second time window by either dropping the occasion to perform the one or more first operations within the first time window or dropping the occasion to perform the one or more second operations within the second time window at least according to at least one sharing factor, the at least one sharing factor defines a relationship between a number of dropped occasions to perform the one or more first operations and a number of dropped occasions to perform the one or more second operations.

2. The wireless device of claim 1, wherein
the processor is further configured to receive, via the at least one radio from a cellular base station, a Radio Resource Control (RRC) message indicating the at least one sharing factor.

3. The wireless device of claim 2, wherein
a value of each of the at least one sharing factor is comprised in the RRC message, or
an identifier of each of the at least one sharing factor is comprised in the RRC message, and the processor is further configured to determine the value of each of the at least one sharing factor based on a pre-defined relationship between an identifier of the sharing factor and a respective value of the sharing factor.

4. The wireless device of claim 1, wherein the relationship defines that every k collisions between first time windows and second time windows, the wireless device shall drop m occasions to perform the one or more first operations and drop n occasions to perform the one or more second operations, wherein, each of m and n is an integer equal to or larger than 0, and k is equal to a sum of n and m.

5. The wireless device of claim 4, wherein the relationship further defines the following absolute prioritization:
the occasion to perform the one or more first operations is always dropped in the case that the collision between a first time window and a second time window happens, and
the occasion to perform the one or more second operation in the second time window is always dropped in the case that the collision between a first time window and a second time window happens.

6. The wireless device of-any claim 1, wherein the first time window is a time window for Layer-3 operation or a time window for Layer-1 operation.

7. The wireless device of claim 6, wherein the time window for Layer-3 operation is a Synchronization Signal Block based radio resource management Measurement Timing Configuration (SMTC).

8. The wireless device of claim 6, wherein the time window for Layer-1 operation at least comprises any of a time window for Radio Link Monitoring (RLM), a time window for Beam Failure Detection (BFD), a time window for Candidate Beam Discovery (CBD), a time window for Layer-1 Reference Signal Received Power (RSRP) measurement, and a time window for Layer-1 Signal-to-Noise and Interference Ratio (SINR) measurement.

9. The wireless device of claim 1,
wherein, the second time window comprises a plurality of patterns, and
wherein the processor is further configured to handle said at least one collision according to a plurality of sharing factors each defining a relationship between the number of dropped occasions to perform the one or more first operations within first time windows and a number of dropped occasions to perform the one or more second operations within second time windows with a specific pattern.

10. The wireless device of claim 9, wherein the value of each of the plurality of sharing factors depends on a type of the one or more second operations to be performed within a second time window with a corresponding pattern.

11. The wireless device of claim 9,
wherein, the second time window comprises a plurality of patterns, and
wherein the processor is further configured to handle said at least one collision according to one single sharing factor defining a relationship between the number of dropped occasions to perform the one or more first operations within first time windows and a number of dropped occasions to perform the one or more second operations within second time windows with any pattern.

12. The wireless device of claim 9, wherein the second time window is a Multi-Universal Subscriber Identity Module (MUSIM) gap.

13. The wireless device of claim 1, wherein
the processor is further configured to handle said at least one collision by either dropping the occasion to perform the one or more first operations within the first time window or dropping the occasion to perform the one or more second operations within the second time window according to one or more pre-defined rules,
wherein the one or more pre-defined rules indicating the wireless device to drop the one or more second operations within the second time window in the case that the one or more first operations relate to one or more aperiodic events.

14. The wireless device of claim 13, wherein the one or more aperiodic events at least comprise any one or more of transmission of Message (Msg) 1 to Msg 5 during a Random Access Channel (RACH) procedure, and first valid Channel Quality Indicator (CQI) feedback in Secondary Cell (SCell) activation.

15. The wireless device of claim 1, wherein the processor is further configured to
receive, via the at least one radio an instruction from a cellular base station, an instruction indicating to either drop at least one coming occasion to perform the one or more first operations within at least one first time window or drop at least one coming occasion to perform the one or more second operations within at least one second time window in the case that at least one collision between the at least one first time window and the at least one second time window happens, wherein, the number of the at least one coming occasion to be dropped is pre-defined or configurable, and
handle the at least one collision by dropping the at least one instructed occasion, wherein, the instruction is aperiodically transmitted.

16. The wireless device of claim 15, wherein the instruction is transmitted via Downlink Control Information (DCI) or Medium Access Control Control Element (MAC CE).

17. The wireless device of claim 1, wherein the processor is further configured to perform Radio Resource Management (RRM) procedure according to an increased latency in the case that at least one occasion to perform the one or more first operations is dropped due to said at least one collision.

18. The wireless device of claim 17, wherein the latency is increased according to a count of the dropped occasions to perform the one or more first operations due to said at least one collision.

19. The wireless device of claim 1, wherein the at least one sharing factor is pre-defined.

20. A method for a wireless device, comprising:
taking repeatedly appeared first time windows as occasions to perform one or more first operations related to a first network; and
taking repeatedly appeared second time windows as occasions to perform one or more second operations related to a second network different from the first network,
wherein the method further comprising handling at least one collision between a first time window as an occasion to perform the one or more first operations within the first time window and a second time window as an occasion to perform the one or more second operations within the second time window by either dropping the occasion to perform the one or more first operations within the first time window or dropping the occasion to perform the one or more second operations within the second time window at least according to at least one sharing factor, the at least one sharing factor defines a relationship between a number of dropped occasions to perform the one or more first operations and a number of dropped occasions to perform the one or more second operations.

21-23. (canceled)
